(19) United States
(12) Patent Application Publication
(10) Pub. No.: US 2008/0287880 A1
(43) Pub. Date: Nov. 20, 2008

(54) Dispensing Assembly Including a Syringe or Cartridge, a Closing Cap, and a Mixer

(75) Inventor: Wilhelm A. Keller, Merlischachen (CH)

Correspondence Address: FOLEY AND LARDNER LLP;SUITE 500, 3000 K STREET NW, WASHINGTON, DC, 20007, US

(73) Assignee: Mixpac Systems AG

(21) Appl. No.: 11/629,353

(22) PCT Filed: Jul. 1, 2005
(86) PCT No.: PCT/CH05/00370

§ 371 Date: Dec. 12, 2006

(30) Foreign Application Priority Data
Jul. 8, 2004 (CH) 1169/04

(51) Int. Cl. B05C 17/005

(52) U.S. Cl. 604/191

(57) ABSTRACT

The invention relates to a system for dispensing two components, which comprises a syringe or cartridge, a closing cap and a mixer. The aim of the invention is to provide a system of the aforementioned kind wherein the closing cap is detachable fastened on the syringe or cartridge and the mixer is non-detachable fastened on the cartridge. For this purpose, the fastening means are configured accordingly. The inner bead on the closing cap, in the zone of transition to the cap interior, is provided with a bevelled section that rests on the retaining cams or the retaining bead of the cartridge, while the retaining means on the mixer engage behind the retaining means on the cartridge, thereby forming a non-detachable connection. The invention provides an inexpensive and yet reliable system for dispensing two components, especially for use in dental and medical technology.

### CROSS-REFERENCE TO RELATED APPLICATIONS

This application is the National Phase of PCT/CH2005/000370, filed Jul. 1, 2005, and published as WO 2006/005206, which in turn claims priority to Switzerland Application No. 1169/04, filed Jul. 8, 2004, the contents of these applications are incorporated herein by reference.

### FIELD OF THE INVENTION

The present invention relates to an assembly for dispensing two components, including a syringe or cartridge, a closing cap, and a mixer, the latter parts being provided with means for connecting the closing cap or the mixer to the syringe or cartridge.

Such an assembly is intended in particular for single use applications in the field of dental and medical technique and destined to be discarded after use. In order to be used, the closing cap is removed and the mixer is attached and secured. Such assemblies, which are discarded after a single use, are subject to relatively strict cost requirements.

### PRIOR ART

U.S. Pat. No. 5,584,817 discloses a syringe assembly having means for maintaining the needle on the appliance after use, thereby allowing a better disposal thereof. The disclosed holder and the measures that are taken are relatively complicated.

U.S. Pat. No. 5,722,829 discloses a dispensing device where the coupling between the dispensing appliance and the mixer comprises a rotary plate for releasable or non-releasable connecting the mixer.

### SUMMARY OF THE INVENTION

In this prior art, the elimination of disposable syringes is not mentioned and it is therefore the object of the present invention to propose an assembly that has been simplified in view of a cost reduction such that a rational and cost-efficient manufacture is possible. This is accomplished by an assembly wherein the connecting means are arranged to connect the closing cap detachable and the mixer non-detachable to the syringe or cartridge.

### BRIEF DESCRIPTION OF THE DRAWINGS

The invention will be explained in more detail hereinafter with reference to drawings of exemplary embodiments:

FIG. 1 shows in a perspective view and schematically a first assembly,

FIG. 2 shows a cartridge or double syringe in a longitudinal section and in a horizontal projection,

FIG. 3 shows an attached closing cap in a longitudinal section,

FIG. 4 shows a longitudinal section through an attached mixer,

FIG. 5 shows a variant of the embodiment of FIG. 1,

FIG. 6 shows a cross-section of the cartridge according to FIG. 5,

FIG. 7 shows a cross-section of the attached closing cap according to FIG. 5,

FIG. 8 shows a cross-section of the attached mixer according to FIG. 5,

FIG. 9 shows a cross-section of an attached adapter and a mixer, and

FIG. 9A shows a cross-section according to line IXA-IXA in FIG. 9.

### DETAILED DESCRIPTION OF THE INVENTION

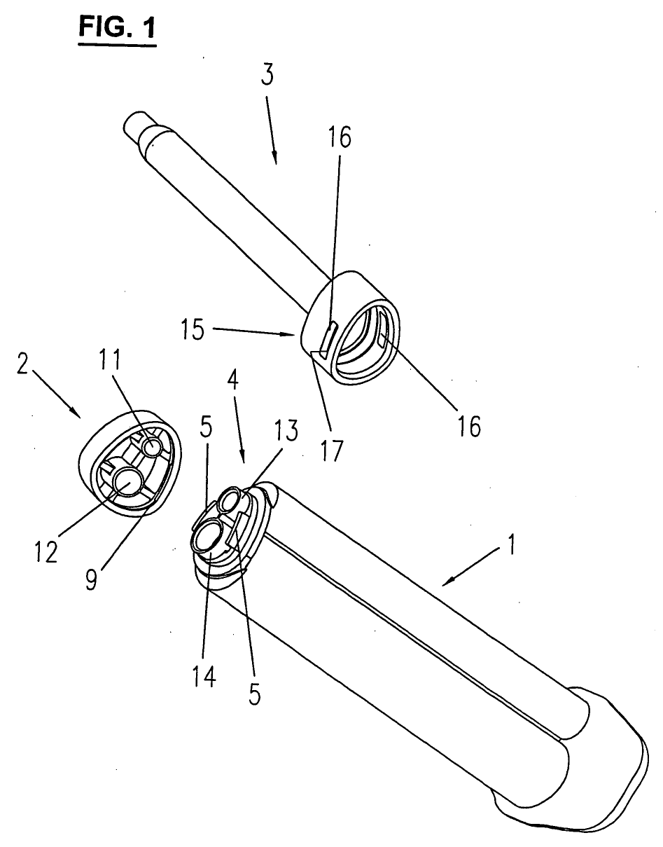

The assembly according to FIG. 1 consists of a double cartridge or double syringe 1, of a closing cap 2 and of a mixer 3. It is essential to the invention that the closing cap is removable from the cartridge while the mixer shall be attached in such a manner that it is no longer removable and resists the load during the dispensing operation.

Outlet flange 4 of cartridge 1 comprises two retaining cams 5 located on both sides of outlets 13 and 14. These retaining cams 5 are made elastic and comprise a step 6 as well as on their front or outlet sides a beveled surface 7 that facilitates an insertion of the mixer or the closing cap.

It is further apparent in FIGS. 1 and 3 that the open end 8 of closing cap 2 is provided with a circumferential inner bead 9 having a bevel 10 at its junction with the cap interior in order to facilitate the withdrawal of the closing cap from the cams. The closing cap further comprises two plugs 11 and 12 which sealingly engage in the corresponding outlets 13 and 14 of the cartridge.

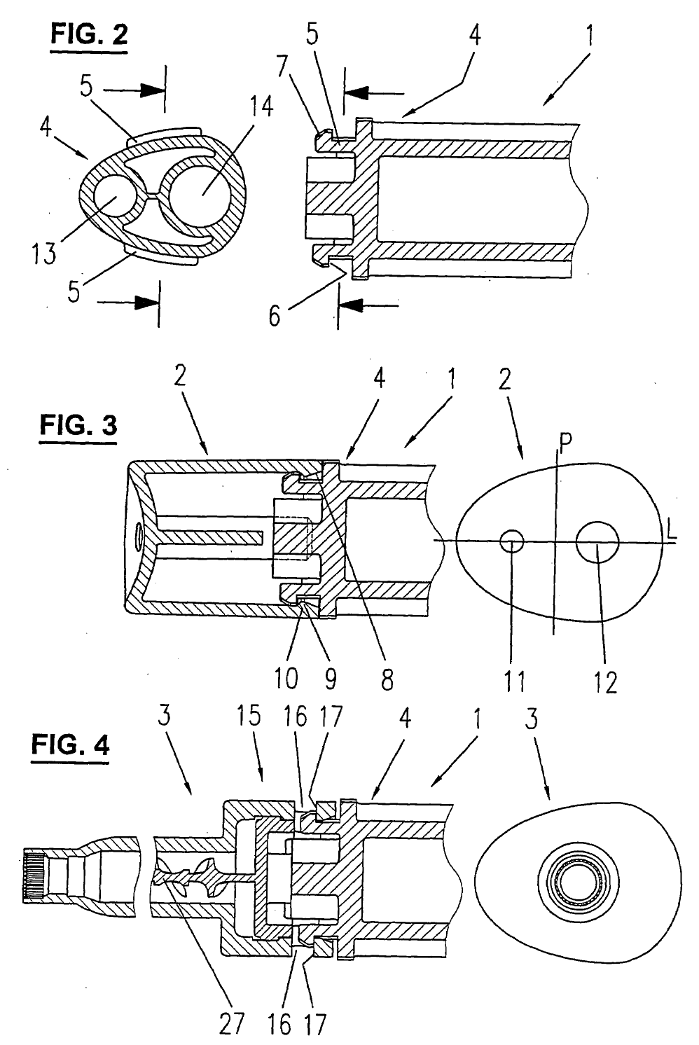

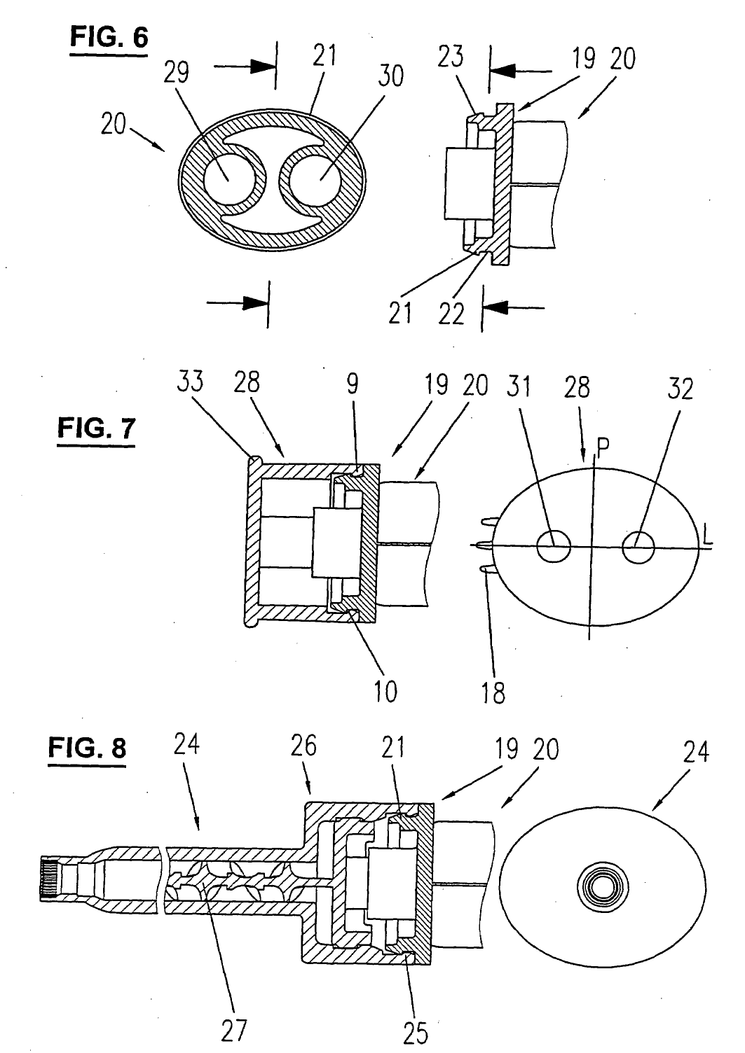

Furthermore, it follows from FIGS. 1, 2, and 3 that the cartridge has two containers whose cross-sectional areas and consequently whose volumes are different from 1:1. In this exemplary embodiment, the horizontal projection of cartridge outlet flange 4, of the closing cap and of mixer inlet portion 15 is asymmetrical with respect to one of the axes L and P, here with respect to transversal axis P, i.e. oval-shaped. This oval shape has the effect of a coding means that allows attaching the closing cap and the mixer to the cartridge directionally and in an unequivocal position. In the case of a 1:1 design of the containers, the corresponding parts have a horizontal projection that is symmetrical with respect to both axes L and P, here an elliptical one, as it is illustrated in FIGS. 6 to 8.

In FIG. 1 and in the sectional view of FIG. 4 it is apparent that inlet portion 15 of mixer 3 is provided on its sides, i.e. at the location of retaining cams 5 of the cartridge, with respective slots 16 in which retaining cams 5 engage in such a manner that steps 6 of the retaining cams engage behind edge 17 on the cartridge side of slots 16. Once they have snapped in, it is no longer possible to remove the mixer without destroying it.

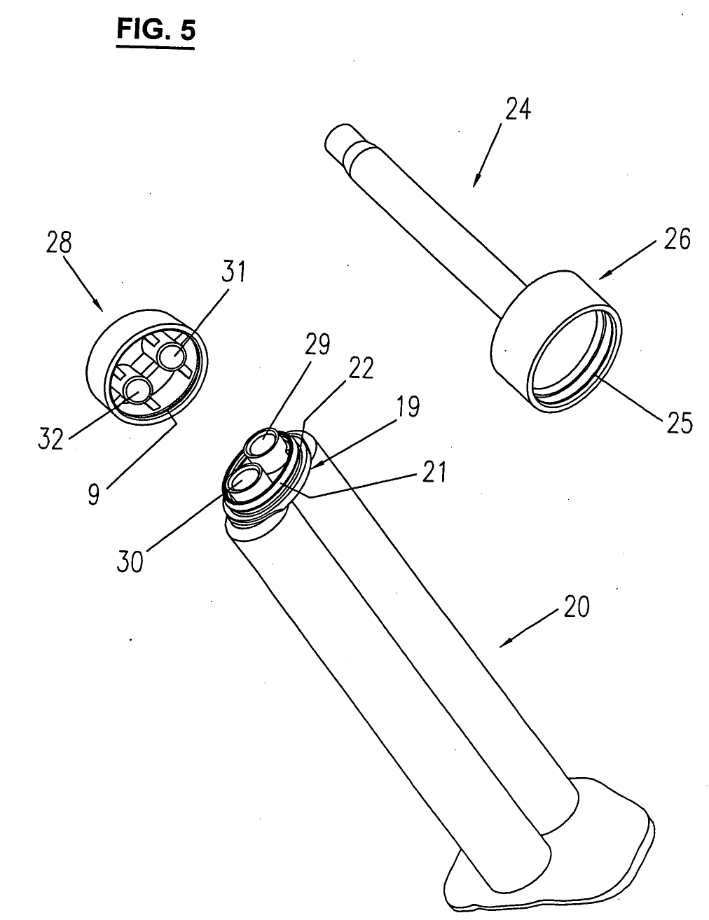

In the embodiment variant according to FIGS. 5 to 8, flange 19 of cartridge 20 has a circumferential retaining bead 21 followed by an adjacent circumferential groove 22 and provided with a bevel 23 in the outlet direction.

Circumferential inner bead 9 of closing cap 28 is the same as that of closing cap 2 according to FIG. 3 and has the same bevel 10 that rests on the upper edge of the cartridge groove in the closed condition and allows removing the closing cap. This closing cap comprises two identical plugs 31 and 32 here.

At its inlet portion 26, mixer 24 of FIG. 8 has an inner bead 25 that is complementary to groove 22 at the retaining bead of the cartridge and snaps into groove 22, thereby establishing a non-releasable connection between the cartridge and the mixer. The remaining elements of the mixer, such as mixing element 27, are the same as those according to FIG. 4.

A comparison of the two closing caps 2 and 28 according to FIGS. 3 and 7 shows that in the case of a cross-sectional ratio of the containers of 1:1, the elliptical shape according to FIG. 7 is appropriate, whereby it is not essential in which one of the positions, rotated by 180°, the closing cap or the mixer is attached to the cartridge, whereas if the cross-sectional ratio of the containers is different from 1:1, it is useful for a better handling to provide a geometrical coding e.g. in the form of oval shape according to FIG. 3, thereby facilitating an attachment of the closing cap or of the mixer in the correct orientation.

In addition to the geometrical design, coding ribs 18 may be provided both on the closing cap and on the mixer, on one hand, and on the cartridge, on the other hand, thereby further facilitating the directional and correct attachment particularly of the mixer. Moreover, the manipulation of the closing cap, particularly its withdrawal, is further facilitated by a handle 33 at its closed end.

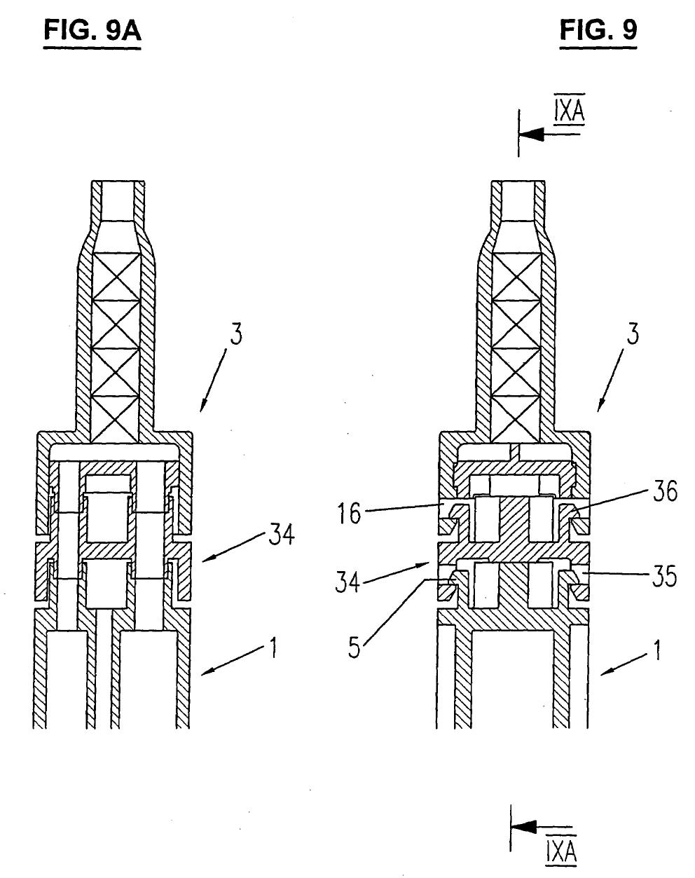

In the exemplary embodiment according to FIGS. 9 and 9A, an adapter 34 is arranged between cartridge 1 and mixer 3. In this embodiment, adapter 34 has two slots 35 in which retaining cams 5 on the cartridge engage in order to engage behind slots 35 of the adapter and to secure the latter to the cartridge. At the other end, the adapter comprises retaining cams 36 similar to retaining cams 5 of the cartridge which engage in slots 16 at mixer 3.

Based on this exemplary embodiment, many variations are possible. Thus, the adapter may have any desired length, may have a flexible design or be made of a flexible material, or may be angled. The coupling on the outlet side of the adapter is designed as a mixer coupling.

It goes without saying that the adapter may also be designed for the exemplary embodiment according to FIGS. 5-8, in which case the adapter may have an inner bead like inner bead 25 on mixer 24 on its cartridge side and either the retaining cams 36 or a circumferential retaining bead with an adjacent circumferential groove on its outlet side, or other coupling means. In principle, the horizontal projection of the adapter is the same as that of the corresponding cartridge or syringe and of the mixer.

For an easy removal of the closing cap and for the retention of the mixer, however, the external shape of the cartridge or the mixer or the closing cap is not decisive but at most a facilitating factor. Essential therefor is the interaction of the retaining cams or of the circumferential retaining bead on the cartridge and the design of the slots respectively of the circumferential inner bead on the mixer or adapter and on the closing cap.

What is claimed is:

1. An assembly for dispensing two components, including a syringe or cartridge, a closing cap, and a mixer, the latter parts being provided with means for connecting the closing cap or the mixer to the syringe or cartridge, wherein the connecting means are arranged to connect the closing cap detachable and the mixer non-detachable to the syringe or cartridge.

2. An assembly according to claim 1, wherein the connecting means include retaining cams on the syringe or cartridge and an inner bead on the closing cap and slots on the mixer that correspond to the retaining cams.

3. An assembly according to claim 1, wherein the connecting means include a retaining bead on the syringe or cartridge and an inner bead on the closing cap and a circumferential inner bead on the mixer.

4. An assembly according to claim 2, wherein the inner bead on the closing cap has a bevel at its junction with the cap interior that rests on the retaining cams or the retaining bead on the cartridge while the slots or the inner bead on the mixer are arranged to engage behind the retaining cams or the retaining bead on the syringe or cartridge.

5. An assembly according to claim 1, wherein for a cross-sectional ratio of the containers of 1:1, the horizontal projection of the outlet flange of the cartridge, of the closing cap, and of the inlet portion of the mixer has a shape that is symmetrical with respect to both axes, more particularly elliptical.

6. An assembly according to claim 1, wherein for a cross-sectional ratio of the containers that is different from 1:1, the horizontal projection of the outlet flange of the cartridge, of the closing cap, and of the inlet portion of the mixer has a shape that is asymmetrical with respect to one of the two axes, more particularly oval.

7. An assembly according to claim 1, wherein an adapter is arranged between the cartridge or syringe and the mixer.

8. An assembly according to claim 7, wherein the adapter has the same coupling means as the mixer on its cartridge side and the same coupling means as the cartridge or syringe on its outlet side.

9. An assembly according to claim 7, wherein the horizontal projection of the adapter has a shape that is symmetrical with respect to both axes, more particularly an elliptical one, or a shape that is asymmetrical with respect to one of the two axes, more particularly an oval one.
